(19) United States
(12) Patent Application Publication
(10) Pub. No.: US 2025/0206112 A1
(43) Pub. Date: Jun. 26, 2025

(54) CONVERTIBLE TOP HAVING A CONVERTIBLE TOP LINKAGE

(71) Applicant: Webasto SE, Stockdorf (DE)

(72) Inventors: Heinrich WÜLLRICH, Stockdorf (DE); Alexander HAIMERL, Stockdorf (DE)

(21) Appl. No.: 18/971,466

(22) Filed: Dec. 6, 2024

(30) Foreign Application Priority Data
Dec. 22, 2023 (DE) 10 2023 136 552.5
Feb. 6, 2024 (DE) 10 2024 103 228.6

(51) Int. Cl. B60J 7/14

(52) U.S. Cl. CPC B60J 7/143

(57) ABSTRACT

A convertible top having a top linkage, displaceable between a cover position spanning a vehicle interior and a storage position releasing the vehicle interior towards the top and having a link arrangement on each side in relation to a vertical longitudinal convertible-top center plane, the link arrangements having a rear main-link arrangement pivotably mounted on a corresponding main bearing, and a front bearing link, on which a rigid cover element is fastened which extends in the transverse convertible-top direction and fixable to a vehicle front header when in the cover position. A stop link arrangement is pivotably mounted on the front bearing link and has a stop link having a stop surface, the stop link taking up a rest position, where the stop surface is exposed in the cover position and being pivoted to an active position, where the stop surface abuts against counter stop element in the storage position.

### CROSS-REFERENCE TO RELATED APPLICATION(S)

This application claims the benefit of German patent application No. 10 2023 136 552.5, filed on Dec. 22, 2023; and German patent application No. 10 2024 103 228.6, filed on Feb. 6, 2024, which are incorporated herein by reference in their entirety.

### TECHNICAL FIELD

A convertible top having the features of the preamble of claim 1.

### BACKGROUND

Such a convertible top is known, for example, from the publication DE 102 94 214 B4 and represents a so-called RHT (retractable hard top), which is a component of a convertible vehicle. The convertible top comprises a convertible-top linkage, by means of which rigid roof shells, which form a convertible top cover, are displaceable between a cover position, which covers a vehicle interior and in which the rigid roof shells are disposed flush behind one another, and a storage position, which releases the vehicle interior towards the top and in which the rigid roof shells are received by a rear convertible-top storage space of the vehicle together with the convertible-top linkage. In relation to a vertical longitudinal convertible-top center plane, the convertible-top linkage comprises a link arrangement on either of two sides, the link arrangement comprising a rear main-link arrangement, which is designed as a four-bar linkage and has two main links pivotably mounted on a main bearing. The main-link arrangement is connected to a bearing link via an intermediate link arrangement, one of the rigid roof shells which is a rigid convertible-top element extending in the transverse convertible-top direction being mounted on the bearing link. This rigid roof shell can be fixed to a front header of the vehicle when in the cover position and is disposed above a rear roof shell in the convertible-top storage space when in the storage position.

### SUMMARY

The object of the invention is to create a convertible top of the make mentioned above whose storage behavior is optimized in the storage position.

According to the invention, this object is attained by the convertible top having the features of claim 1.

According to the invention, a convertible top is thus proposed which comprises a convertible top linkage, by means of which a convertible top cover is displaceable between a cover position spanning a vehicle interior and a storage position releasing the vehicle interior towards the top and which comprises a link arrangement on each of two sides in relation to a vertical longitudinal convertible-top center plane, the link arrangements each comprising a rear main-link arrangement, which is pivotably mounted on a corresponding main bearing, and a front bearing link, on which a rigid cover element is fastened which extends in the transverse convertible-top direction and is fixable to a front header of the vehicle in question when in the cover position. In order to unambiguously define the position of the front bearing link and thus the position of the convertible-top element fastened on the front bearing link when they are in the storage position, a stop link arrangement is pivotably mounted on each front bearing link and comprises a stop link having a stop surface, the stop link taking up a rest position, where the stop surface is exposed, when in the cover position and being pivoted to an active position, where the stop surface abuts against counter stop element, when in the storage position. The convertible top according to the invention thus has a device formed by the stop link arrangement which is activated in the storage position of the convertible-top linkage and in this position interacts with a counter stop element. In the cover position of the convertible top and/or of the convertible-top linkage, the stop link arrangement is inoperative, i.e., without function.

The convertible top according to the invention is in particular a so-called RHT (retractable hard top), on whose convertible-top linkage at least two rigid roof shells are mounted, whose relative position to one another in the storage position can be unambiguously defined by means of the stop link arrangement. However, it is also conceivable that the convertible top according to the invention is designed as a folding top or surface bow top, in which the position of the two front bearing links relative to other convertible-top areas on which the counter stop elements are formed can be defined by means of the stop link arrangements of the convertible-top linkage.

In a special embodiment of the convertible top according to the invention, the counter stop element is disposed on a convertible-top part whose trajectory in relation to the main bearing is prespecified by the pivoting behavior of the rear main-link arrangement. In the case of a convertible top designed as an RHT, this convertible-top part can be formed by a rear roof shell which, in the cover position in relation to the orientation of the vehicle in question, is disposed at the rear of the roof shell which is disposed on the bearing links and forms the rigid convertible-top element extending in the transverse convertible-top direction. Both roof shells preferably have an upright arrangement, i.e., they are pivoted by approximately 70° to 110° in relation to the alignment in the cover position. The edges which are on the front-side in the cover position and point towards the vehicle front in the cover position, therefore point upwards in the storage position.

In particular, if the convertible-top part disposed at the rear in the cover position covers an outer side of the rigid convertible-top element when in the storage position, the outer side forming an outer viewing surface and the rigid convertible-top element being disposed on the bearing links, it is advantageous if the stop links of the stop link arrangements disposed on either of two sides engage over an edge of the rigid convertible-top element when in its active position. This edge is in particular the edge which borders on the front header of the vehicle in question when in the cover position.

In order to be able to precisely control the pivot movement of the stop link, it can be advantageous for the stop link arrangement to form a multi-bar arrangement, in particular a four-bar arrangement, formed on the front bearing link. Preferably, two links of the four-bar linkage are pivotably mounted on the bearinglink. One of these links is formed by the stop link. Another link forms a coupler between the two links pivotably mounted on the bearing link.

In a further special embodiment of the convertible top according to the invention, the stop link arrangements disposed on either of two sides are pivotable in relation to the corresponding bearing link by means of a drive rod, which is preferably articulated on an intermediate link disposed between the corresponding main-link arrangement and the corresponding bearing link. This makes it possible to force the control of the movement of the stop link by moving the main-link arrangement. Alternatively, the drive rod can also be driven by another drive, for example by a drive of a front closing mechanism of the convertible top.

In another special embodiment of the convertible top according to the invention, the intermediate link is a component of a multi-bar arrangement designed in particular as a seven-bar arrangement between the main-link arrangement and the front bearing link. The multi-bar arrangement defines the pivoting movement of the front bearing link in relation to the main-link arrangement. The multi-bar arrangement can in turn be driven by the main-link arrangement via a coupling link.

In a preferred embodiment of the convertible top according to the invention, the stop link has a pivot axis which coincides with a pivot axis of a locking hook of a front closing mechanism in order to keep the number of the articulation points and pivot axes and thus the design effort to a minimum. The pivot planes of the locking hook and the stop link are thus aligned at least essentially parallel to one another.

In order to be able to secure the position of the front bearing link and/or the rigid convertible-top element in relation to the counter stop element in the storage position, a preferred embodiment of the convertible top according to the invention has a stop lock.

For example, the stop lock is pivotably mounted on a link of the stop link arrangement, which, as explained above, can form a four-bar linkage.

In order to avoid requiring a separate drive for the stop lock, the stop lock can be driven by a front closing drive in a preferred embodiment of the convertible top according to the invention. The front closing drive drives in particular a front closing linkage, which pivots the locking hook of the front closing mechanism. The front closing linkage or the locking hook itself can be coupled to the stop lock via a coupling link.

In order to be able to secure different convertible-top areas, in particular two roof shells disposed one behind the other, with respect to their relative position when in the cover position, the counter stop element in a preferred embodiment of the convertible top according to the invention forms a locking counter element in the cover position, the locking counter element interacting with a closing hook pivotably mounted on the front bearing link. This closing hook can also be driven by the front closing drive. In particular, the closing hook is driven synchronously with the drive of the locking hook of the front closing mechanism.

In a further special embodiment of the convertible top according to the invention, the main bearings of the link arrangement disposed on either of two sides are each displaceably guided on a guide rail. This makes it possible to lower the unit consisting of the convertible-top linkage and the convertible top cover in relation to a vehicle body in order to realize the storage position of the convertible top. Of course, it is also conceivable that the main bearing of the convertible-top linkage is designed to be fixed to the vehicle body and/or be rigid with respect to the vehicle body.

Further advantages and advantageous embodiments of the subject matter of the invention can be derived from the description, the drawing and the claims. The invention relates to all combinations comprising at least two features disclosed in the description, the claims and/or the figures; i.e., each feature mentioned in the description can in itself be part of the claimed subject matter independently of the further features and/or specifications mentioned in the respective context.

### BRIEF DESCRIPTION OF DRAWINGS

An exemplary embodiment of a convertible top according to the invention is illustrated in a schematically simplified manner in the drawing and is described in more detail hereinafter.

FIG. 1 shows a schematic partial side view of a convertible vehicle having a convertible top according to the invention in its convertible top position.

FIG. 2 shows a view of the convertible top corresponding to FIG. 1, but in an intermediate positon during the displacement to a storage position.

FIG. 3 also shows a view of the convertible top corresponding to FIG. 1, but in another intermediate positon during the displacement to the storage position.

FIG. 4 shows a view of the convertible top corresponding to FIG. 1, but in another intermediate positon during the displacement to the storage position.

FIG. 5 shows a side view of the convertible top in a storage position.

FIG. 6 shows an inner view of the top in its convertible top position.

FIG. 7 shows an inner view of the convertible top corresponding to FIG. 6, but in an intermediate positon during the displacement to the storage position.

FIG. 8 shows an inner view of the convertible top of the storage position, but in an unsecured state.

FIG. 9 shows an inner view of the convertible top corresponding to FIG. 8, but in a secured state.

FIGS. 10a and b show side views of a convertible top linkage of the convertible top in the convertible top position from the outside and from the inside.

FIGS. 11a and b show side views of the convertible top linkage corresponding to FIGS. 10a and b, but in a first intermediate positon during the displacement to the storage position.

FIGS. 12a and b show side views of the convertible top linkage corresponding to FIGS. 10a and b, but in a second intermediate positon during the displacement to the storage position.

FIGS. 13a and b show side views of the convertible top linkage corresponding to FIGS. 10a and b before being lowered to the storage position.

FIG. 14 shows a perspective rear view of the convertible top linkage in the convertible top position.

FIG. 15 shows a top view of the convertible top linkage in the convertible top position.

FIG. 16 shows a partly transparent view of the convertible top linkage in its convertible top position.

FIG. 17 shows a view of the convertible top linkage corresponding to FIG. 16, but in a first intermediate position during the displacement to the storage position.

FIG. 18 shows a view of the convertible top linkage corresponding to FIG. 16, but in an unsecured storage position.

FIG. 19 also shows a view of the convertible top linkage corresponding to FIG. 16, but in the secured storage position.

FIG. 20 shows a rear view of a lifting mechanism of the convertible top linkage in the convertible top position.

FIG. 21 shows a view of the lifting mechanism corresponding to FIG. 20 in a first intermediate position when lowering the top.

FIG. 22 shows a view of the lifting mechanism corresponding to FIG. 20, but in a second intermediate position when lowering the top.

FIG. 23 also shows a view of the lifting mechanism corresponding to FIG. 20, but in the lowered storage position of the top

### DETAILED DESCRIPTION

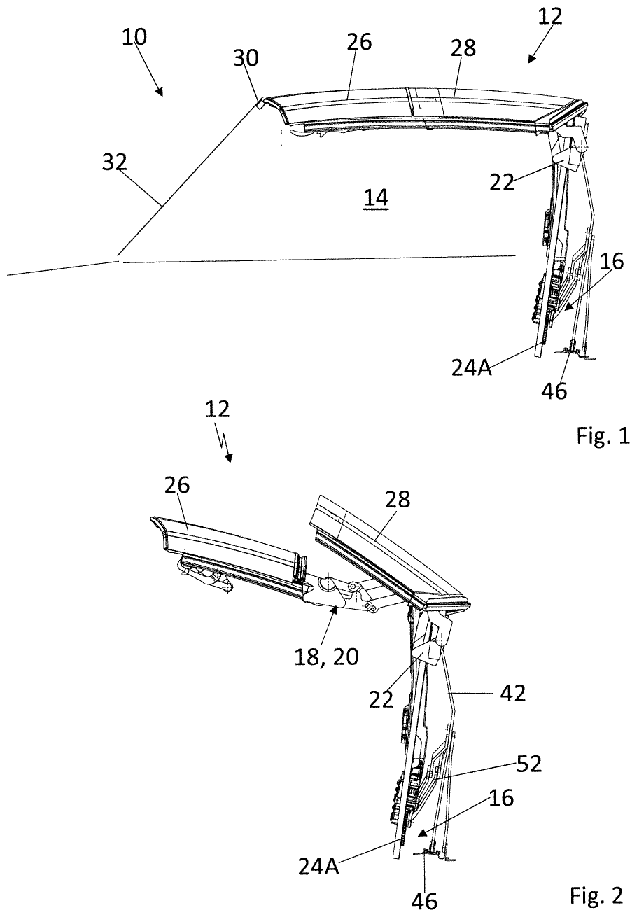

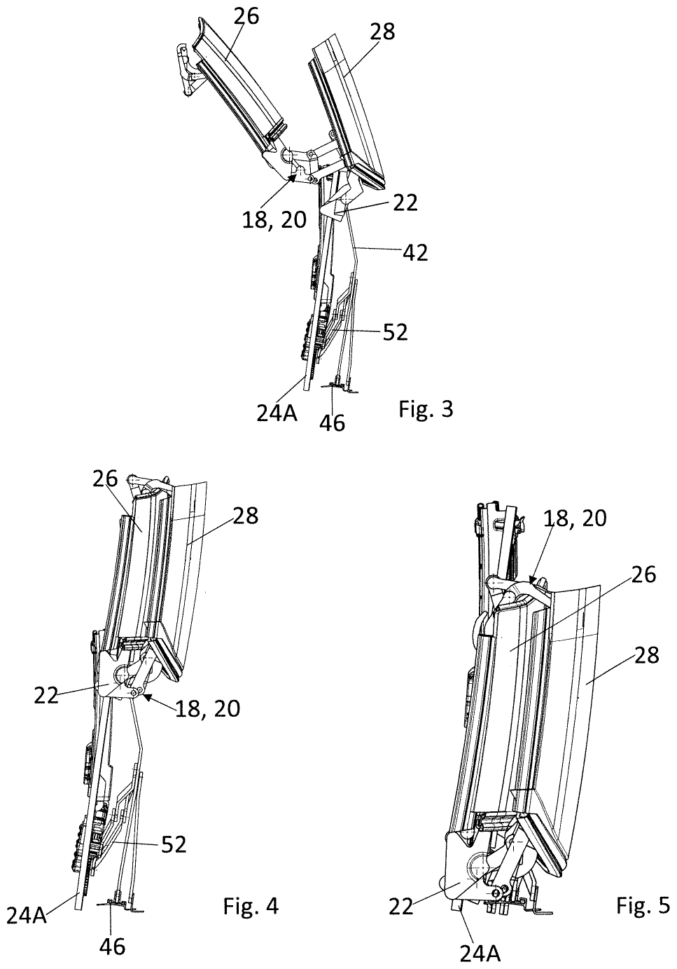

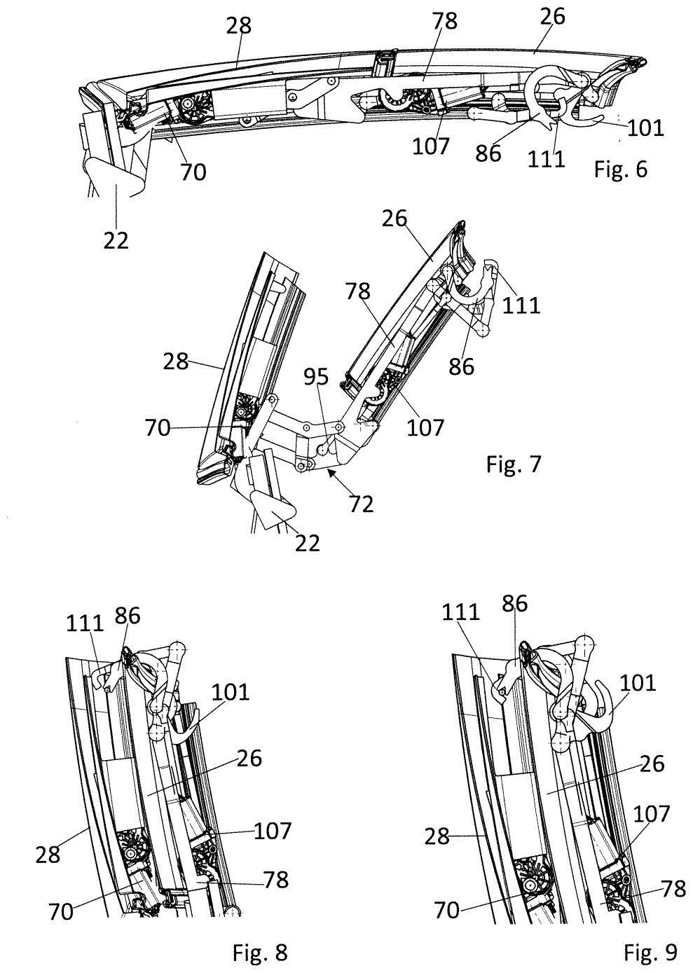

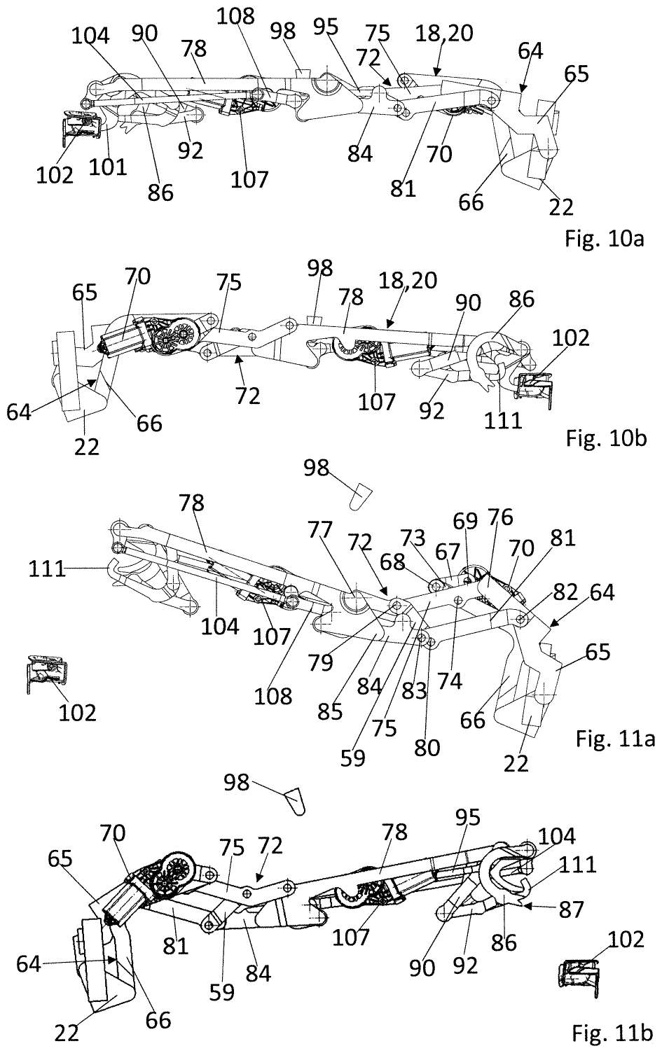

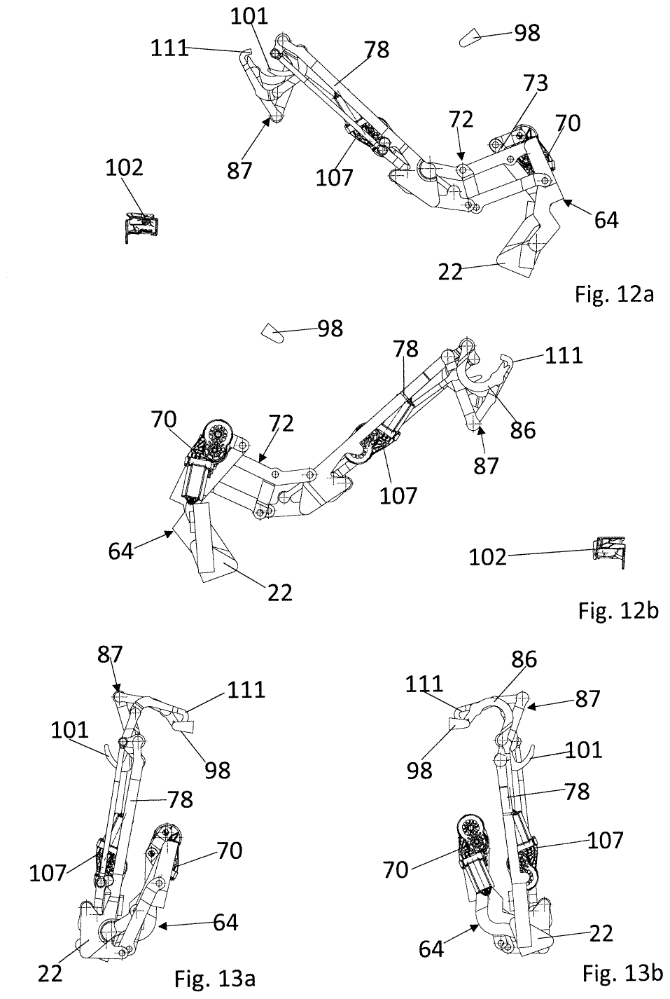

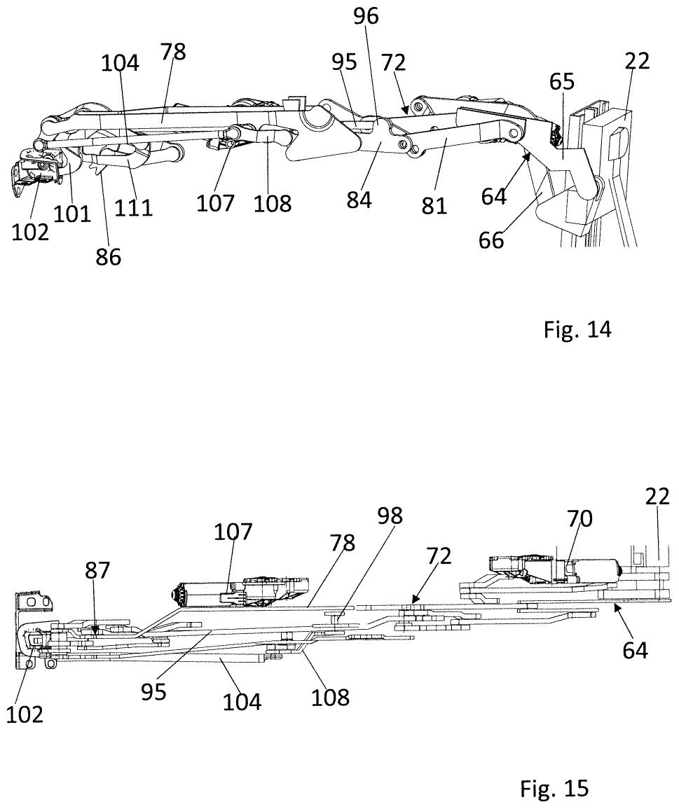

The drawing shows a convertible vehicle 10, which is provided with a displaceable convertible top 12, which is displaceable between a convertible top position (shown in FIG. 1), i.e., a closed position, in which it spans a vehicle interior 14, and a storage position (shown in FIG. 5, for example), i.e., an open position, in which it is disposed in a top storage area 16 disposed to the rear of vehicle interior 14. The convertible top 12 comprises a convertible top linkage 18, which comprises a link arrangement 20 on both of two sides in relation to a vertical longitudinal center convertible-top plane, the link arrangements 20 each being pivotably mounted on a respective main bearing 22. Each main bearing 22 is displaceable in the vertical direction of the vehicle on a fixed guide rail 24A or 24B fixed to the body of the vehicle.

The convertible top 12 is designed as a so-called RHT (Retractable Hard Top) and comprises two rigid roof shells 26 and 28, which have outer sides which are disposed flush behind one another in the convertible top position when viewed in the longitudinal direction of the vehicle and are disposed in an upright position in the top storage area 16 in the storage position in such a manner that the front roof shell 26 is disposed in front of the rear-side roof shell 28 in the front direction of the vehicle. The edges of the roof shells 26 and 28 pointing in the direction of the vehicle front in the convertible top position therefore point upwards. The rear roof shell 28 overlaps the outer side of the front roof shell 26 from behind (see FIG. 5). In the convertible top position, the front roof shell 26 is fixed to a front header 30 of the convertible vehicle 10, which forms an upper transverse leg of a frame of a windshield 32.

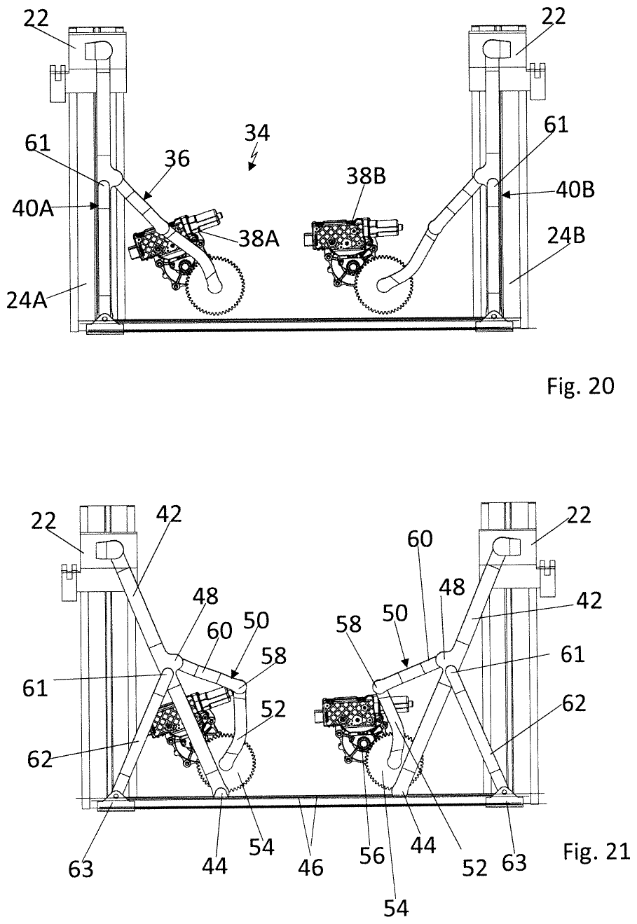

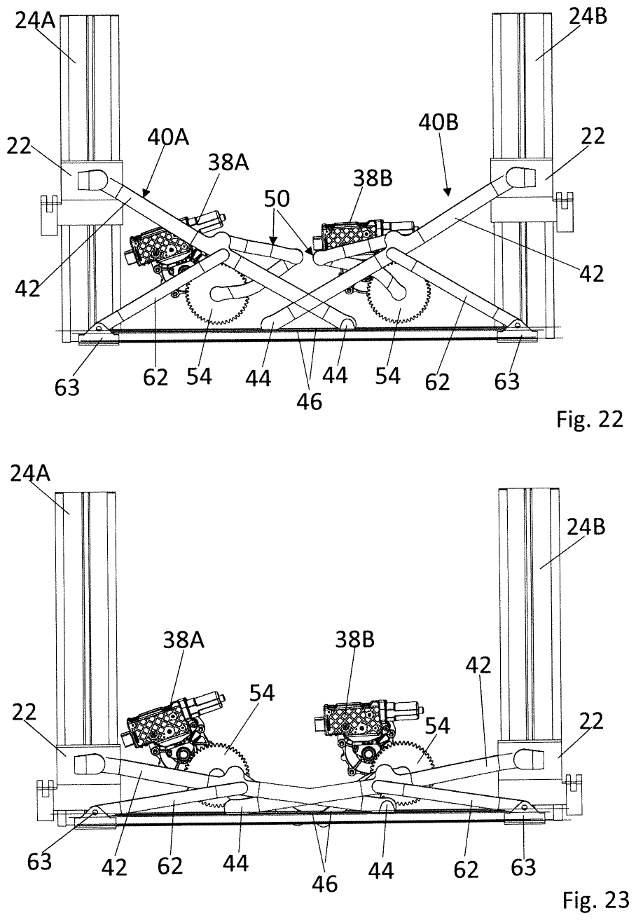

In order to be able to adjust the main bearing 22 on the guide rails 24A and 24B, the convertible top 12 has a drive arrangement 34 which is designed as a lifting mechanism and comprises a lever arrangement 36, which is articulated to the two main bearings 22 and is driven by two drive motors 38A and 38B (see FIGS. 20 to 23).

For each of the two main bearings 22, the lever arrangement 36 comprises a lever unit 40A or 40B, respectively, which can be driven by the respective drive motor 38A or 38B, respectively. The drive motors 38A and 38B are driven synchronously so that the lever units 40A and 40B can be adjusted synchronously. For example, synchronization can be achieved by meshing the gears of the two lever units 40A and 40B (not shown). It is also conceivable that the two lever units 40A and 40B are driven by a shared drive motor.

The two lever units 40A and 40B each comprise a plurality of links which are pivotable in the transverse direction of the vehicle and/or the transverse convertible-top direction. In particular, the lever units 40A and 40B each comprise a main link 42, whose one end is articulated to the respective main bearing 22 and whose other end is pivotably connected to a slider 44, which is displaceably guided in a respective guide track 46 disposed in a fixed manner in the bodywork and extending in the transverse convertible-top direction. A drive link arrangement 50 is articulated to the main link 42 at a respective hinge point 48 and comprises a drive lever 52 which is non-rotatably connected to a toothed wheel 54 which is drivable by a drive pinion 56 of the respective drive motor 38A and/or 38B. At the end facing away from the respective toothed wheel 54, the drive levers 52 are each connected to a link 60 of the drive link arrangement 50 via a hinge point 58, the link 60 being articulated to the respective main link 42 at the hinge point 48.

At a further hinge point 61, a bearing link 62 is articulated to the main link 42 and in turn is articulated to a respective bearing block 63, which is fixed to the bodywork and/or stationary relative to the guide rails 24A and 24B. In the lifted position of the main bearings 22 shown in FIG. 20, the drive link arrangements 50 each assume an over dead center position, so that the lifted position of the main bearing 22 is secured.

When the drive motors 38A and 38B, which are designed as electric motors, are actuated from the lifted position shown in FIG. 20, an adjusting torque is exerted on the main bearings 22 via the drive link arrangement 50 and the main link 42 so that these can be displaced on the guide rails 24A and 24B and transferred to a lowered position shown in FIG. 23.

Alternatively, it is also conceivable that the drive link arrangements 50 are each articulated to the relevant support link 62. Furthermore, it is also conceivable that the drive link arrangements 50 comprise not only two, but also three or more links.

The link arrangements 20 of the convertible top linkage 18 disposed on both sides of the vertical longitudinal convertible-top center plane are at least largely mirror-symmetrical to one another, for which reason reference is made below essentially only to the link arrangement 20 disposed on the left in relation to the forward direction of travel of the convertible vehicle 10. The link arrangement disposed on the right in relation to the forward direction of travel of the convertible vehicle 10 is designed in a similar manner.

Starting from the height-adjustable main bearing 22, the link arrangements 20 each comprise a four-bar linkage 64, which forms a first multi-bar arrangement and which comprises two main links 65 and 66, which are pivotably mounted on the respective main bearing 22. In addition, the four-bar linkage 64 comprises a coupling link 67 which is in the form of a drive link and which is articulated to the main link 66 at a hinge point 68 and is connected to a drive pinion of a drive motor 70 at a pivot point 69, the drive motor 70 being in the form of an electric motor and being rigidly fastened to the main link 65 constituting a bearing link. The drive motor 70 is to be regarded as a component of the four-bar linkage. The rear roof shell 28 is fastened to the main link 65.

The four-bar linkage 64 is coupled to a seven-bar linkage 72, which represents a second multi-bar arrangement, via a coupling link 73, which is connected to the four-bar linkage 64 at the hinge point 68 on the one hand and is connected to a base link 75 of the seven-bar linkage 72 at a hinge point 74 on the other hand. To form the seven-bar linkage 72, the base link 75 is articulated to the main link 65 of the four-bar linkage 64 at one end at a hinge point 76 and to a double-shell bearing link 78 at a second end in a hinge point 77, the bearing link 78 being disposed on the bow side in the convertible top position of the top 12 and on which the front roof shell 26 is mounted. The base link 75 is slightly angled and has a hinge point 79 at its bend point, a coupling link 59 being articulated at the hinge point 79 and being articulated to a further base link 81 of the seven-bar linkage 72 at a hinge point 80, the base link 81 being articulated to the main link 65 of the four-bar linkage 64 at a hinge point 82. At its end facing away from the main link 65, the base link 81 has a further hinge point 83, via which it is connected to an intermediate link 84, which is connected to the bearing link 78 at a hinge point 85. The two base links 75 and 81, the main link 65, the coupling link 59, the intermediate link 84 and the bearing link 78 thus form the seven-bar linkage 72 via the described hinge points 76, 77, 79, 80, 82, 83 and 85.

By means of the four-bar linkage 64 and the seven-bar linkage 72, it is possible to pivot the rear roof shell 28 to the upright position from the closed position shown in FIG. 1 by actuating the drive motor 70, and to move the front roof shell 26, which is mounted on the bearing links 78, to the upright position as well, in which it is disposed directly in front of the rear roof shell 28 (see FIGS. 4 and 5).

Furthermore, the two link arrangements 20 are each provided with a stop link 86, which is a component of a stop link arrangement 87. The stop link arrangement 87 forms a four-bar linkage with the bearing link 78 and comprises, in addition to the stop link 86, which is pivotably mounted on the bearing link 78 at a hinge point 88, a link 90 mounted on the bearing link 78 at a hinge point 89 and connected to a coupler 92 via a hinge point 91 at its end facing away from the hinge point 89, the coupler 92 being articulated to the stop link 86 at a hinge point 93. The stop link 86 has a fork-like stop surface 97 on the end face, the stop surface 97 representing the effective surface of the stop link 86.

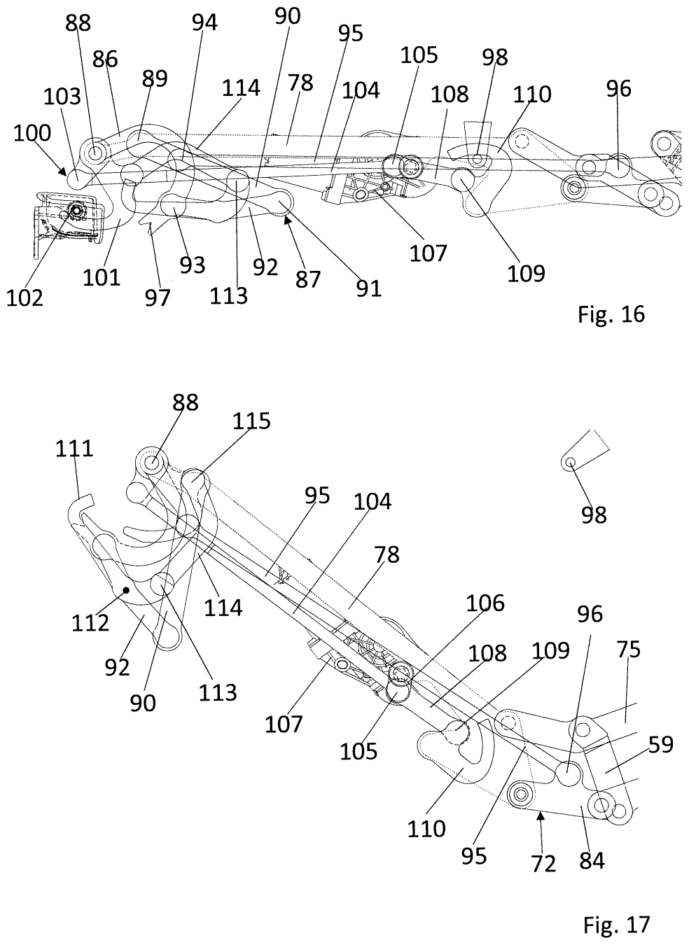

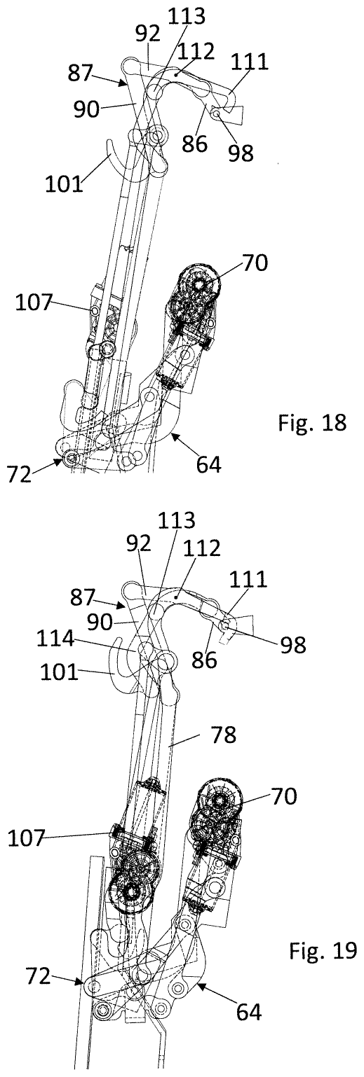

For actuation, the link 90 of the stop link arrangement 87 is connected to a drive rod 95 at a hinge point 94, end of the drive rod 95 facing away from the stop link arrangement 87 being connected to the intermediate link 84 of the seven-bar linkage 72 at a hinge point 96. Via the drive rod 95, the stop link 86 can be pivoted from its rest position shown in FIG. 16 to the active position shown in FIGS. 18 and 19, where it engages over a front edge of the front roof shell 26 and the stop surface 97 rests against a counter stop element 98, which is disposed on the underside of the rear roof shell 28 and is designed in the manner of a roll. The relative position between the two roof shells 26 and 28 in the storage position of the convertible top 12 is defined by the stop links 86 which are disposed on both sides and rest against the counter stop elements 98 disposed on both sides via their stop surfaces 97.

To secure the convertible top 12 in the convertible top position, a closing unit 100 is provided at each of the link arrangements 20 disposed on either of two sides, the closing unit 100 comprising a front locking hook 101 whose pivot axis coincides with the pivot axis of the stop link 86, i.e., which can also be pivoted about the pivot axis defined by the hinge point 88 and, in its locking position shown in FIG. 16, is engaged with a locking element 102 disposed on the front header 30. For the drive, the locking hook 101 is connected to a lock rod 104 via a hinge point 103, and end of the lock rod facing away from the locking hook 101 being articulated to a drive lever 106 via a hinge point 105, the drive lever 106 being driven by a front closing drive 107 designed as an electric motor. A further closing rod 108 is articulated to the drive lever 106 via the hinge point 105 and is connected to a closing hook 110 via a hinge point 109, the closing hook 110, when in the convertible top position of the convertible top 12, being engaged with the counter stop element 98, which forms a flying stop and is disposed on the underside of the rear roof shell 28. This secures the two roof shells 26 and 28 to each other in the convertible top position.

In order to secure the two roof shells 26 and 28 to each other in the storage position, the link arrangements 20 disposed on either of two sides also have a stop lock 111, which is pivotably mounted on the coupling 92 of the stop link arrangement 87 at a hinge point 112 and is connected to a coupling link 114 via a hinge point 113, the coupling link 114 being articulated to the locking hook 101 at a hinge point 115. By actuating the front closing drive 107, it is therefore possible to pivot the stop lock 111 between a release position (see FIG. 18) and a locking position (see FIG. 19) via the lock rod 104, the locking hook 101 and the coupling link 114, where it engages with the counter stop element 98 and thus holds the front roof shell 26 on the rear roof shell 28. This provides an intermediate shell locking mechanism in which support is provided between the various elements within the kinematics. The support is provided on the side of the roof shell 28 on which the movement is initiated when the drive motor 70 is actuated. In the storage position, the two roof shells 26 and 28 are equally curved behind each other. When the roof shells 26 and 28 are moved to the convertible top position, the stop links 86 are pivoted from the active position to the rest position located below the roof shell 26. In the active position, however, the stop links 86 provide stable support between the roof shells 26 and 28. The stop locks 111, which are designed like hooks, allow the roof shells 26 and 28 to be actively locked together in the storage position. The locking mechanism not only prevents the attached roof shell 28 from moving against the displaceable stop link 86, but also prevents the roof shell 28 from moving in the opposite direction. This completely fixes the relative movement of the roof shells 26 and 28 to each other.

### REFERENCE SIGNS

10 convertible vehicle
12 convertible top
14 vehicle interior
16 top storage area
18 convertible top linkage
20 link arrangement
22 main bearing
24A, B guide rail
26 roof shell
28 roof shell
30 front header
32 windshield
34 drive arrangement
36 lever arrangement
38A, B drive motor
40A, B lever unit
42 main link
44 slider
46 guide track
48 hinge point
50 drive link arrangement
52 drive lever
54 toothed wheel
56 drive pinion
58 hinge point
59 coupling link
60 link
61 hinge point
62 support link
63 bearing block
64 four-bar linkage
65 main link
66 main link
67 coupling link
68 hinge point
69 pivot point
70 drive motor
72 seven-bar linkage
73 coupling link
74 hinge point
75 base link
76 hinge point
77 hinge point
78 bearing link
79 hinge point
80 hinge point
81 base link
82 hinge point
83 hinge point
84 intermediate link
85 hinge point
86 stop link
87 stop link arrangement
88 hinge point
89 hinge point
90 link
91 hinge point
92 coupler
93 hinge point
94 hinge point
95 drive rod
96 hinge point
97 stop surface
98 counter stop element
100 closing unit
101 locking hook
102 locking element
103 hinge point
104 lock rod
105 hinge point
106 drive lever
107 front closing drive
108 closing rod
109 hinge point
110 closing hook
111 stop lock
112 hinge point
113 hinge point
114 coupling link
115 hinge point

1. A convertible top, comprising:
a convertible top linkage, by which a convertible top cover is displaceable between a cover position spanning a vehicle interior and a storage position releasing the vehicle interior towards the top and which comprises a link arrangement on each of two sides in relation to a vertical longitudinal convertible-top center plane,
the link arrangements each comprising a rear main-link arrangement, which is pivotably mounted on a corresponding main bearing, and a front bearing link, on which a rigid cover element is fastened which extends in the transverse convertible-top direction and is fixable to a front header of the vehicle in question when in the cover position,
wherein a stop link arrangement is pivotably mounted on the front bearing link and comprises a stop link having a stop surface, the stop link taking up a rest position, where the stop surface is exposed, when in the cover position and being pivoted to an active position, where the stop surface abuts against counter stop element, when in the storage position.

2. The convertible top according to claim 1, wherein the counter stop element is disposed on a convertible-top part whose trajectory in relation to the main bearing is prespecified by the pivoting behavior of the rear main-link arrangement.

3. The convertible top according to claim 1, wherein the stop link engages over an edge of the rigid convertible-top element when in its active position.

4. The convertible top according to claim 1, wherein the stop link arrangement forms a multi-bar arrangement formed on the front bearing link.

5. The convertible top according to claim 1, wherein the stop link arrangement is pivotable in relation to the bearing link by means of a drive rod, which is articulated on an intermediate link disposed between the main-link arrangement and the bearing link.

6. The convertible top according to claim 5, wherein the intermediate link is a component of a multi-bar arrangement between the main-link arrangement and the front bearing link.

7. The convertible top according to claim 1, wherein the stop link has a pivot axis which coincides with a pivot axis of a locking hook of a front closing mechanism.

8. The convertible top according to claim 1, wherein a stop lock which secures the front bearing link to the counter stop element when in the storage position.

9. The convertible top according to claim 8, wherein the stop lock is pivotably mounted on the stop link arrangement.

10. The convertible top according to claim 8, wherein the stop lock is drivable by a front closing drive and is connected to a front closing element via a coupling link.

11. The convertible top according to claim 1, wherein the counter stop element forms a lock counter element in the cover position, the lock counter element interacting with a closing hook which is pivotably mounted on the front bearing link and is drivable by the front closing drive.

12. The convertible top according to claim 1, wherein the convertible-top cover comprises at least two rigid roof shells and in that one of the roof shells is the rigid cover element which is fastened to the front bearing link and the other roof shell is mounted on the rear main-link arrangement.

13. The convertible top according to claim 1, wherein the main bearing is displaceable on a guide rail.
